(19) United States
(12) Patent Application Publication
(10) Pub. No.: US 2011/0216400 A1
(43) Pub. Date: Sep. 8, 2011

(54) Optical apparatus for magnifying a view of an object at a distance

(76) Inventor: Masataka Shirasaki, Winchester, MA (US)

(21) Appl. No.: 12/798,358

(22) Filed: Apr. 2, 2010

Related U.S. Application Data
(60) Provisional application No. 61/339,305, filed on Mar. 3, 2010.

(51) Int. Cl. G02B 23/00

(52) U.S. Cl. 359/366

(57) ABSTRACT

Described are new magnifying apparatus based on two dimensional arrays of micro magnifying modules (MMMs) positioned along a plane perpendicular to the axis of the MMMs. In addition, the structure may include a two dimensional array of micro beam multipliers (MBMs) to improve the quality of the image. The micro beam multipliers are positioned along a plane parallel to the array of micro magnifying modules. The array of micro magnifying modules, with or without the micro beam multipliers, may be constructed as a thin plate with a thickness of a few millimeters, through which the object is viewed. An object at a distance appears in the magnifying apparatus as a magnified image and the magnifying apparatus can be used for viewing an object at a distance in a way similar to the use of a conventional magnifier for viewing an object in a short distance.

### RELATED APPLICATION

This application claims the benefit of provisional Application No. 61/339,305, filed Mar. 3, 2010, which application is incorporated herein by reference.

### BACKGROUND OF THE INVENTION

The present invention relates to optical magnifying devices for magnifying a view of an object at a distance.

To magnify a view of an object or scene at a distance, the most common apparatus is a telescope. A well known telescope design is a Galileo telescope, which consists of a convex lens and a concave lens. The fundamental function of a telescope is to enlarge the angle of a light ray coming from the object at a distance. In a conventional telescope, a ray with an angle θ1 coming from an object whose distance is virtually at infinity is converted through the telescope into a ray with a larger angle θ2, where both angles are defined as angles with respect to the axis of the telescope. The eye sees the ray with angle θ2, and therefore, sees the object in the direction at angle θ2. Assuming θ2 is in proportion to θ1, the image of the object is magnified and the magnification is given by the ratio θ2/θ1.

More generally, any optical apparatus which converts the ray angle from θ1 to θ2 will magnify the view of the object at a distance. All such apparatus also convert the diameter of a collimated light beam from D1 to D2, where D2 is smaller than D1, and the magnification is given by the ratio D1/D2.

In a conventional telescope, the diameter of the collimated light beam emerging from the telescope determines the view area. Since the collimated light beam is compressed in diameter through the telescope, the view area is only a portion of the cross section of the telescope. To provide a sufficient view area, the diameter of the view area is usually 10 mm or larger. Therefore, conventional telescopes are at least a few centimeters long and cannot be built in a shape of a thin plate.

If the eye is distant from a telescope compared to the size of the view area of the telescope, the eye can view the image only within a small view angle. To view the image outside the view angle, an additional telescope may be placed beside the original telescope. Then the additional telescope provides the view in that direction. This concept may be extended to multiple telescopes, where each additional telescope provides the view in its direction. Several designs using multiple Galileo telescopes are disclosed in U.S. Pat. No. 5,270,859 and US patent application 20090128899. Combined with the multiple telescopes, the total range of the view area may be expanded, but the actual view is limited to the combined view areas of individual telescopes.

In the designs in the prior art using multiple Galileo telescopes, the dimension parallel to the light rays is several times greater than the telescope diameter. An important drawback in these devices is the aberration of the lens. In a conventional single Galileo telescope, the eye pupil is located within only a portion of the output light beam (given here as diameter D2). Actually, the size of eye pupil is much smaller than the beam size D2. Therefore, only a small portion of light in the beam diameter D2 is received by the eye. That is, a point on an object is viewed through only a small portion of each lens of the telescope and the image does not suffer much from the lens aberration. A different point on the object is viewed through a different portion of each lens. Since different points are viewed through different portions of each lens, the image could be distorted due to the lens aberration. However the sharpness of the image is not equivalently degraded. In contrast to the conventional single Galileo telescope, the lens aberration in the multiple Galileo telescope directly affects the sharpness of the images, unless the beam diameter D2 is much larger than the eye pupil size. This is because all rays passing through the entire area of each lens produce a point in the image.

To reduce the length of the telescopes without sacrificing lens aberration, each telescope may be made with a small diameter, and then small D1. Then D2 will be further reduced. However, if the area of diameter D2, from which the light beam is emitted, is small, the beam diverging effect due to diffraction impairs the sharpness of the image. Thus, reducing the telescope length is limited, and therefore, the multiple telescope designs of the prior art cannot be practically built on a scale of a thin plate.

### BRIEF SUMMARY OF THE INVENTION

Conventional telescopes do not provide a large view area and a short length at the same time. To overcome this, a new structure of a magnifying apparatus is proposed. This structure is based on a two dimensional array of micro magnifiers positioned along a plane perpendicular to the axis of the micro magnifiers. This array of micro magnifiers is defined as a magnifier plate and the micro magnifiers are referred to herein as Micro Magnifying Modules (MMMs). In addition, the structure of the invention may include a two dimensional array of micro beam multipliers to improve the quality of the image. The micro beam multipliers are positioned along a plane parallel to the magnifier plate. This array of micro beam multipliers is defined as a beam multiplier plate and the micro beam multipliers are referred to herein as Micro Beam Multipliers (MBMs). The magnifier plate with or without the beam multiplier plate may be constructed as a thin plate with a thickness of a few millimeters, through which the object is viewed. Therefore, with the magnifying apparatus of the invention, an object at a distance appears in the magnifying apparatus as a magnified image. The magnifying apparatus can be used for viewing an object at a distance in a way similar to the use of a conventional magnifier for viewing an object in a short distance.

### BRIEF DESCRIPTION OF THE DRAWING

FIG. 1 is a light ray diagram illustrating the view of a remote object through a magnifying apparatus;

FIG. 2 is a schematic representation of a Galileo telescope;

FIG. 3 is a schematic representation of a generalized magnifying apparatus;

FIG. 4 shows a diagram of a magnifier plate with an array of four MMMs, one for on-axis light beam from the far field image to the eye and one for off-axis light beam;

FIG. 5 shows the MMM that is a main aspect of the invention;

FIG. 6 shows the relevant design parameters for the MMM of FIG. 5;

FIG. 7 illustrates the light beam path for an on-axis beam and an off-axis beam through the MMM;

FIG. 8 illustrates the light wave front in the MMM at the positions shown;

FIG. 9 shows three plots of output ray angle vs. input position for an on-axis beam (center), a slight positive off-axis beam (bottom), and a slight negative off-axis beam (top);

FIG. 10 shows three plots of output ray angle vs. input ray angle for input position at 0 mm (center), input position at −0.9 mm (top), and input position at 0.9 mm (bottom);

FIG. 11 is a schematic representation of a magnifier plate using spaced apart plates to allow focal length and other adjustments;

FIG. 12 illustrates one embodiment of a magnifier plate, comprising a two dimensional array of square unit cells, where the individual MMMs are square;

FIG. 13 illustrates an alternative embodiment of a magnifier plate, comprising a two dimensional array of hexagonal unit cells, where the individual MMMs are hexagonal;

FIG. 14 illustrates three undesirable rays through the MMM;

FIG. 15 illustrates the MMMs with light absorptive areas near the edge of the convex mirror.

FIG. 16 illustrates an additional embodiment of the invention wherein blank portions of the output light are filled by splitting the primary beam into two beams;

FIG. 17 illustrates an embodiment similar to that of FIG. 16 wherein the primary beam is split into three beams;

FIG. 18 shows the result of the beam multiplier plate of FIG. 16 applied to the array of FIG. 12;

FIG. 19 shows the result of the beam multiplier plate of FIG. 17 applied to the array of FIG. 13;

FIG. 20 illustrates a suitable structure for the beam multiplier plate of FIG. 16;

FIG. 21 illustrates an alternative structure for the beam multiplier plate of FIG. 16;

FIG. 22 illustrates a suitable structure for the beam multiplier plate of FIG. 17;

FIG. 23 illustrates an alternative structure for the beam multiplier plate of FIG. 17;

FIG. 24 is a perspective view of an element in the beam multiplier plate of FIGS. 20-23;

FIG. 25 is a perspective view similar to that of FIG. 24 showing an alternative structure for the reflecting elements;

FIG. 26 is an expanded view showing a magnifier plate coupled to a beam multiplier plate;

FIG. 27 is an illustration similar to that of FIG. 4, and when compared with FIG. 4, illustrates the improvement obtained using the beam multiplier plate according to one aspect of the invention;

FIG. 28 is another illustration of the advantages of the beam multiplier plate of the invention comparing the view fields without a beam multiplier plate (top) and with a beam multiplier plate added (bottom);

FIG. 29 is a perspective view of a base plate in a beam multiplier plate;

FIG. 30 is a perspective view of an alternative base plate in a beam multiplier plate;

FIG. 31 illustrates the use of two beam multiplier plates with a square unit shape;

FIG. 32 illustrates the use of two beam multiplier plates with a hexagonal unit shape;

FIG. 33 is an illustration of a primary use of the magnifying apparatus of the invention for viewing objects at a distance;

FIG. 34 shows two embodiments of a magnifier plate wherein the MMMs are tilted for viewing angles that are not normal to the plane of the magnifier plate;

### DETAILED DESCRIPTION OF THE INVENTION

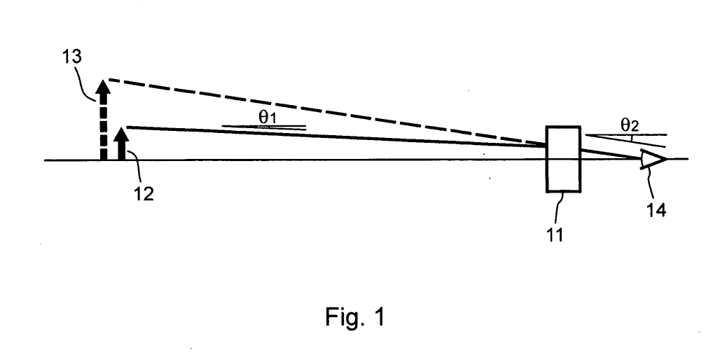

A magnifying apparatus such as a telescope works as shown in FIG. 1. A ray with an angle θ1 coming from an object 12 whose distance is virtually at infinity is converted through a magnifying apparatus 11 such as a telescope into a ray with a larger angle θ2, where both angles are defined as angles with respect to the axis of the apparatus. The eye 14 sees the ray with angle θ2, and therefore, sees the object 13 in the direction at angle θ2. Assuming θ2 is in proportion to θ1, the image of the object is magnified and the magnification is given by the ratio θ2/θ1.

A well known design of Galileo telescope consists of a convex lens and a concave lens, and has the function of enhancing of the traveling angle described in FIG. 1. If a Galileo telescope is designed to make a view area to be, for example, a centimeter in diameter, the total length of the telescope will be several times longer than the diameter, that is, several centimeters. Short focal length lenses may be used to reduce the telescope length, but short focal length lenses have increased lens aberrations.

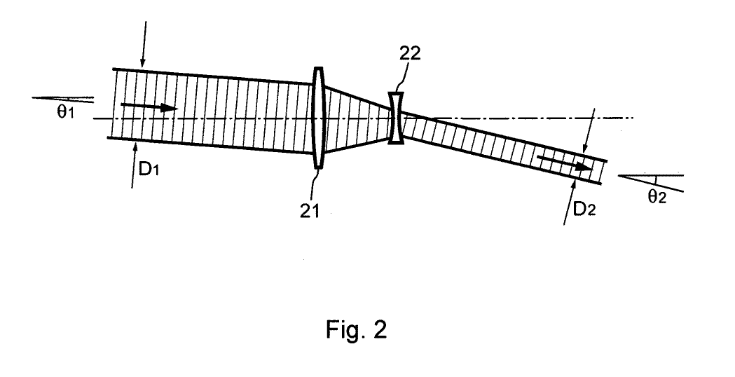

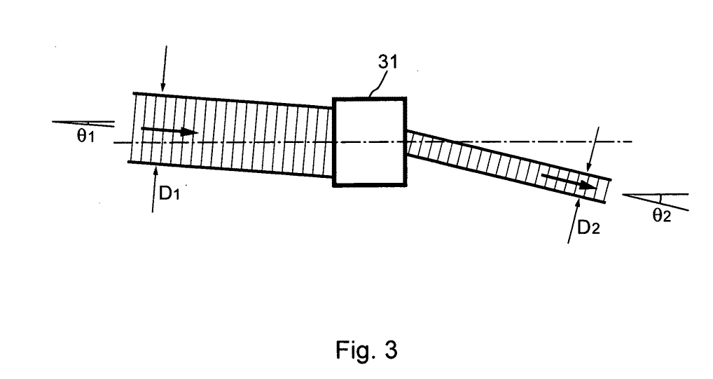

FIG. 2 illustrates a Galileo telescope, converting an input ray having angle θ1 to an output ray with angle θ2. It also converts input collimated light beam with diameter D1 into an output collimated light beam with a smaller diameter D2. In the design of FIG. 2, the input collimated light beam is converged by the convex lens 21 toward its focusing point, but the converging effect is canceled before reaching the focusing point by the concave lens 22. Typically the convex and concave lenses have focal points at the same position. This is a function of a beam expander for light traveling in a backward direction and a beam compressor for light traveling in a forward direction. More generally, as shown in FIG. 3, an optical apparatus 31 which converts the diameter of a collimated light beam from D1 to D2 works as a telescope. In this optical apparatus, the magnification is given by the ratio D1/D2 as is explained below.

From the above results, it is expected that both θ2/θ1 and D1/D2 give the magnification, and therefore, they are the same number. The relation θ2/θ1=D1/D2 is briefly understood as described below using rectangular beam profiles in a one dimensional model. As a convenient model, two collimated light beams with equal diameter Din and with a small difference Din between traveling angles are considered as the input light to the telescope. These collimated light beams overlap when traveling through the telescope. Assuming the beam profiles are rectangular, they are in optically orthogonal modes if the optical phase difference between the phases of the two entering light beams changes 2π across the beam diameter Din at the telescope. The beam orthogonality is maintained throughout the telescope to ensure energy conservation. Therefore, the two collimated light beams emerging from the telescope have an angle difference θout, where the optical phase difference between the phases of the two emerging light beams also changes 2π across the beam diameter Dout. The phase change 2π is equivalent to a distance of the wavelength λ in space. With these relations, Dinθin=Doutθout=λ, and thus, Din/Dout=θout/θin is obtained. Assuming that Din=D1, Dout=D2, and θout/θin=θ2/θ1, θ2/θ1=D1/D2 is obtained.

In many conventional telescope designs, chromatic aberration is an important design issue. Chromatic aberration results from chromatic dispersion due to the refractive index of the lens material and cannot be eliminated using a single lens. Geometrical aberrations may be reduced by using an aspherical lens, but this improvement is limited, especially when the length of the telescope is made short. The relevance of this design issue in the context of the invention will become evident.

The present invention provides a design of a magnifying apparatus to overcome the problem of the apparatus dimensions while a practical view area is maintained. The magnifying apparatus in the present invention consists, in principle, of a uniform array of MMMs in two dimensions. An individual MMM is a small cell, which has the same function as a telescope. That is, an input collimated light beam to an MMM is converted into an output collimated light beam with a smaller diameter, and the light traveling angle is enhanced from θ1 to θ2 as shown in FIG. 3. The period of MMMs in the array is determined so that the gap between the adjacent light beams traveling to the eye be smaller than the size of eye pupils in both directions of the two dimensions. This array of MMMs is defined as the magnifier plate.

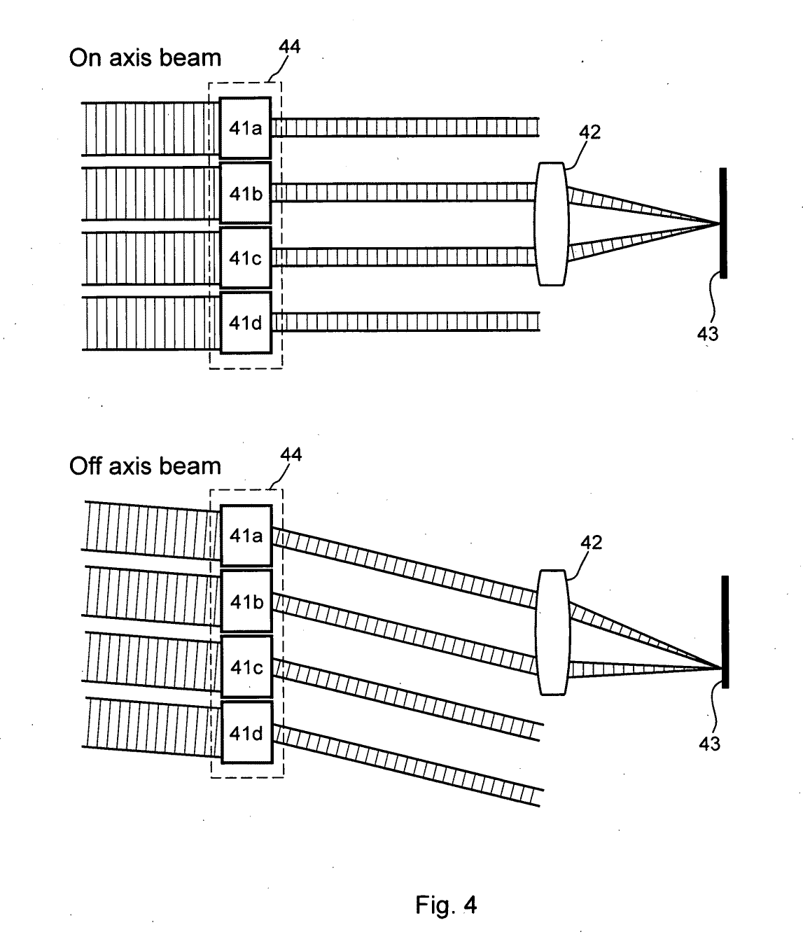

FIG. 4 illustrates the light beams in one dimensional view from the side of the magnifier plate. The magnifier plate produces many light beams emitted from an array of MMMs 41a, 41b, 41c, and 41d, arrayed on the surface of the magnifier plate 44. The view area of the magnifying apparatus is determined virtually by the size of the magnifier plate. The top portion of FIG. 4 shows the light beams entering the magnifier plate in parallel to the axis of MMMs. The light beams exiting the MMMs are parallel to the axis. However, there exist gaps between adjacent light beams when observed in the plane perpendicular to the light traveling direction. The lower portion of FIG. 4 shows the light beams entering the magnifier plate at an angle with respect to the axis. The light beams exiting the MMMs are parallel to each other, but they travel at a magnified angle with respect to the axis. In this case, too, there exist gaps between adjacent light beams when observed in the plane perpendicular to the light traveling direction. The output light beams travel to the crystalline lens 42 of the eye and focus onto a point on the retina 43. If the eye pupil falls into one of the gaps, no light enters the eye and the eye cannot view the object. Therefore, it is important that the gap between the light beams traveling toward the eye is made smaller than the size of the eye pupil. The gap can be made small by either making the transversal dimension of the MMM small, or employing a component to multiply light beams. The latter is the subject of an embodiment of the invention described below. When the size of the gaps is well below the size of eye pupils, the eye does not recognize the gaps, and sees the magnified image of the object without interruption by the gaps.

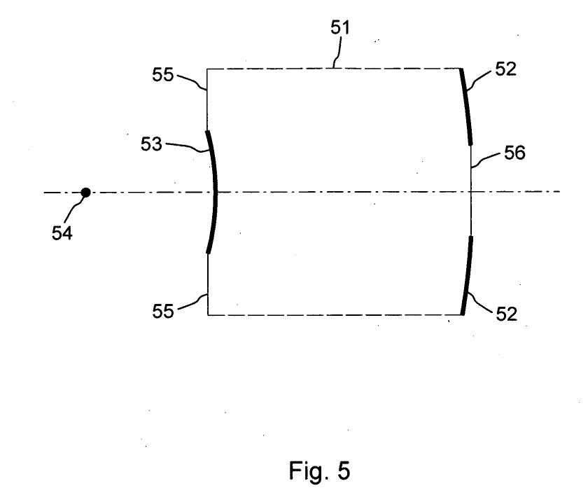

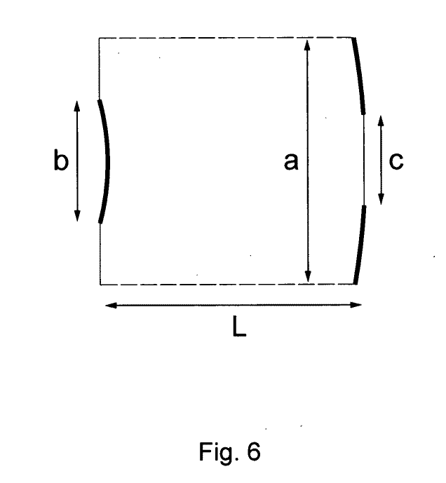

The MMMs are basic building blocks of the apparatus of the invention, and will be described in detail in conjunction with FIGS. 5 and 6. The MMM comprises a body 51 of transparent material, typically glass or a rigid polymer. The magnifying apparatus will typically be used for viewing images in the visible spectrum, and the body 51 should have a high transparency, preferably greater than 95%, to at least one wavelength or wavelength band in the visible spectrum. In some applications, other wavelengths may be of interest, for example, infra red, and will require corresponding high transparency in the wavelength band of interest. For example, for an infra-red telescope the body 51 may be silicon.

The MMM comprises concave mirror 52 and convex mirror 53. The concave mirror has a hole 56 at the center. In a typical design, the concave mirror and the convex mirror have the focal points at the same position 54. The bold curves are the mirrors and the space between the mirrors is filled with transparent material as just described. Since the MMM uses internal reflections in medium 51, chromatic aberration is not an issue. The flat surface 55 on the left side of the MMM, surrounding the convex mirror, is the light entrance window. The flat surface 56 on the right side of the MMM, within the hole at the center of the concave mirror, is the light exit window. The entrance window and the exit window are shown by a thin line in FIG. 5 and are preferably anti-reflection coated or index matched with the external medium. Also to avoid undesired reflections, the outside (right side) surfaces of the concave mirror are preferably black in color. The MMM functions as a beam expander/compressor of collimated light beams, and therefore, both the convex and concave mirrors are preferably exactly or nearly parabolic.

A useful feature of the MMM design is that a light beam through the MMM undergoes internal reflections without encountering a refractive interface. Since the input beam and the output beam are nearly normal to the entrance window and the exit window, respectively, the beam undergoes little refraction through the entire MMM. Thus the MMM magnifies the ray angle with little chromatic aberration.

The two dimensional array of the MMM bodies 51 will typically be a flat plate, with mirror elements 52 and 53 formed in or on body 51. In FIG. 5, the mirrors are shown as depressions in body 51. The mirrors may also be formed as attachments to the surface of body 51. The construction may vary depending on the manufacturing technology used. The preferred structure is that shown, where there are no refractive interfaces.

In typical embodiments, the MMMs are positioned periodically in two dimensions. However, any array geometry, including both periodic and arbitrarily spaced arrays, may be used. Each MMM is small in the longitudinal direction, but not too small in the transversal directions to suppress the light diffraction. With this design, the magnifier plate may be made thin, e.g., in the range 1-8 mm, and emits well collimated light beams with enhanced traveling angles.

The design parameters of an MMM are shown in FIG. 6. The MMM shown in this embodiment is the fundamental case where the mirrors are circular. Other cases will be considered below. In FIG. 6, dimension “a” is the diameter of the concave mirror, dimension “b” is the diameter of the convex mirror, dimension “c” is the diameter of the exit window, L is the distance between the center positions of the concave parabola and the convex parabora. Parameters not illustrated are the focal length F1 of the concave mirror, the focal length F2 of the convex mirror, and the refractive index “n” of the MMM material.

In an illustrative embodiment, “a” is 1.8 mm. “b” is 0.9 mm, “c” is 0.66 mm, L is 1.8 mm, F1 is 2.7 mm, F2 is 0.9 mm, and “n” is 1.5. With these parameters, the magnification of the MMM is F1/F2=3. These parameters may vary for different magnifications or by other factors.

Considering the function of the magnifier plate as a whole, an input collimated light beam to the magnifier plate is converted into a large number of collimated light beams, each with reduced diameter and enhanced traveling angle. As a result, the output light beams have gaps between adjacent beams. The size of a gap between beams entering the eye is preferably well below the size of eye pupils. A recommendation for this design parameter is that the gap be less than 2 mm, and preferably less than 1 mm. This helps the gaps become invisible when the eye is focused at a far distance.

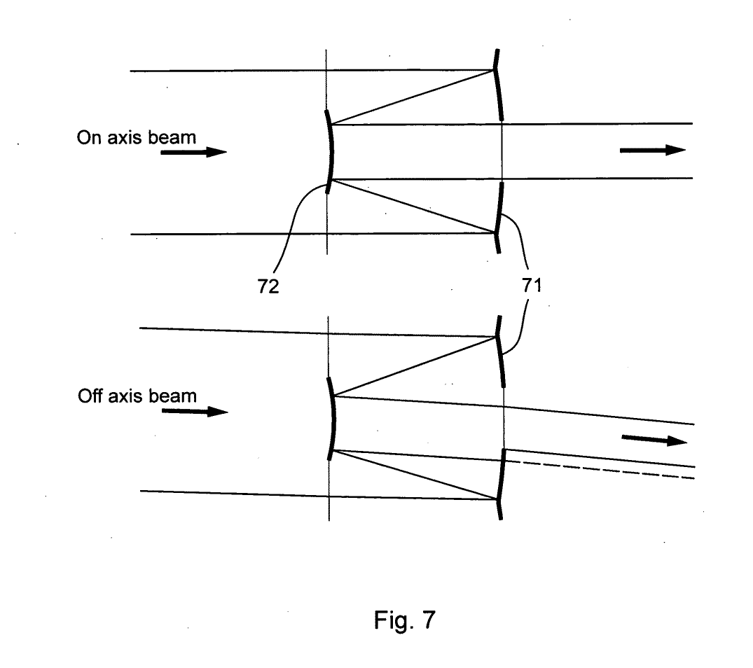

The paths of light beams traveling through the MMM are shown in FIG. 7 for both cases of on-axis input beam and off-axis input beam. The collimated light beam entering the MMM from the left through the light entrance window is reflected back by the concave mirror 71 and the light rays are traveling toward a point on the focal plane of the concave mirror. Before they reach the focal plane, the rays are reflected by the convex mirror 72 and they form a collimated light beam traveling to the right. This is because the concave mirror and the convex mirror have the focal points at the same position. The collimated light beam after reflection by the convex mirror exits the MMM through the light exit window, which is the hole at the center of the concave mirror. As is apparent, the diameter of the output beam is smaller than the input beam diameter.

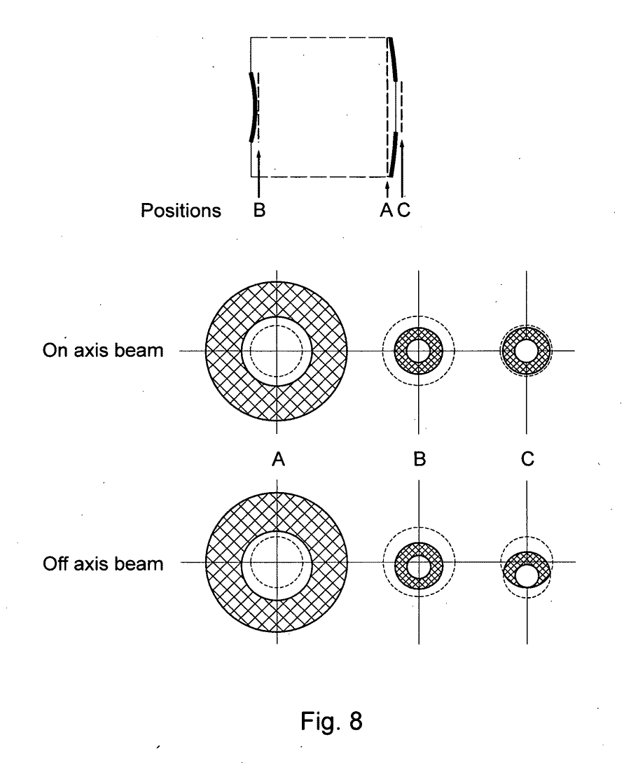

The cross section of a light beam and its position change along the beam path in the MMM. The beam profile and position at three different positions A, B, and C, along the light path in the MMM are illustrated in FIG. 8. Position A is just before the light reaches the concave mirror, position B is just before the light reaches the convex mirror, and position C is at the light exit window, which is the center portion of the concave mirror. First, when the input light beam is on axis, the beam profile at A has a diameter of 1.8 mm, where the center portion with a diameter of 0.9 mm is blocked by the convex mirror. The beam profile at B is simply compressed from that at A into the ⅓ size. The beam profile at C is the same as that at B. When the input light beam is off axis, the beam profile at A has the same diameter of 1.8 mm as the previous case, but the area, which is blocked by the convex mirror, is off center. The beam profile at B is compressed from that at A into the ⅓ size. In addition, the entire beam is also moved off center. The beam profile at C is further moved off center and a portion of the beam is out of the light exit window. Therefore, a portion of the beam is blocked by the concave mirror as shown in FIG. 8.

Although a pair of the mirrors has no chromatic aberration, the light is refracted through the entrance window and the exit window as was shown in FIG. 7. As mentioned above, the light passes through the windows in directions nearly normal to the windows, so the refractions at the entrance and the exit windows mostly cancel each other and little chromatic aberration is expected. The numerical simulations show that the change of the output angle due to the index change within the visible wavelengths is much less than 10⁻⁴ radians, and therefore does not affect the quality of the image in the view.

As was described earlier, the function of the MMM is to convert a collimated light beam into a collimated light beam with a smaller diameter. The geometric aberration of the MMM may cause a slight change of the traveling direction of the ray within the output beam diameter. Unlike conventional telescopes, if the parallel rays of input are converted into rays of output, which are not exactly parallel to each other, the sharpness of the image may be impaired. In conventional telescopes, only a portion of rays which are within the eye pupil enters the eye and, as long as the rays within the eye pupil are parallel, the sharpness does not suffer. Rays whose traveling directions change gradually across the light beam will only cause image distortion. On the other hand, in the MMM of the present invention, all output rays within the light beam enter the eye. Therefore, in order to create a sharp image, it is important that all output rays are parallel to each other.

To ensure the sharpness of the image, the parallelism of output rays is analyzed, while the input light beam is collimated and the input rays are parallel to each other. The design parameters for this analysis were given earlier with the description of FIG. 6. The MMM for the model used in the analysis is 1.8 mm long, and 1.8 mm in diameter, and the refractive index of the material in the MMM is 1.5. The actual shapes of the convex and concave mirrors may be parabolic or non-parabolic. In the analysis, both concave mirror and convex mirror are assumed to be parabolic mirrors with different curvatures. The concave mirror has a focal length of 2.7 mm, with a hole of 0.66 mm in diameter at the center. The convex mirror has a focal length of 0.9 mm and a diameter of 0.9 mm. Since the ratio of the focal lengths is 3, a magnification of 3 is expected with the MMM. The input beam size of 1.8 mm and the magnification of 3 suggest that the output beam size is 0.6 mm. Since the angular diffraction of this collimated output beam due to the beam size of 0.6 mm is not greater than the angular resolution of human eyesight, the quality of the image does not suffer from light diffraction and the analysis can be carried out using ray optics.

In the model for the analysis, as mentioned earlier, both concave and convex mirrors are parabolic mirrors and they share the same focal point. Under this condition, the ray trace shows that all input rays parallel to the axis will exit the MMM as parallel rays with no aberration. This means that the output ray angle is zero with respect to the axis regardless of the position of the ray across the entrance window. This perfect parallelism is obtained analytically only when the input light beam is parallel to the axis.

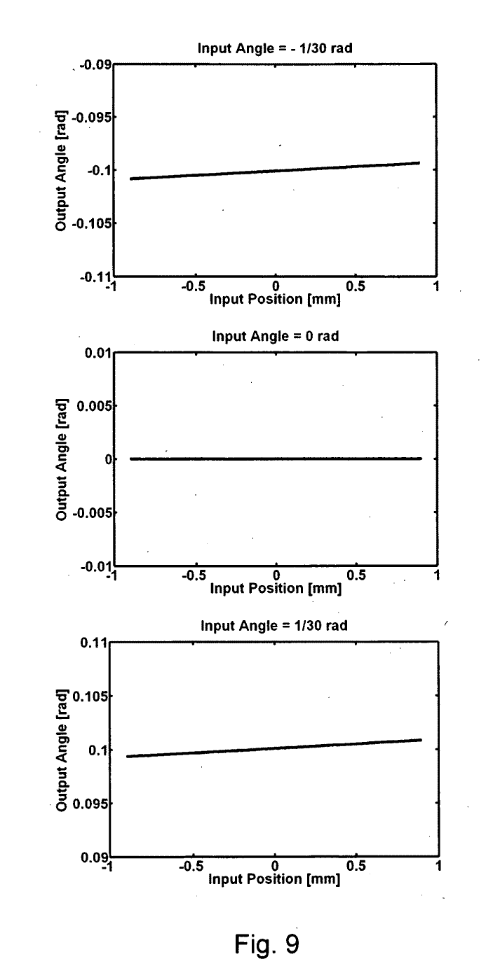

When the input collimated light beam is at an angle with respect to the axis, aberrations may be observed. This means that the output rays are no longer parallel to each other and the output ray angles are not uniform. The design parameters used in the analysis give the magnification of 3, and therefore, the input ray angle of 1/30 radians should be magnified into the output ray angle of 0.1 radians. The numerical analysis was carried out for three input ray angles, − 1/30 radians, 0 radians, and 1/30 radians, and the results are shown in FIG. 9. Each curve indicates the relation between the input ray position across the entrance window of the MMM and output ray angle with respect to the axis. In the actual MMM, the rays would be blocked by the convex mirror near the center positions.

However, the analysis was carried out as if the rays were not blocked. The analysis indicates that non-uniformity of the output ray angle is within 10⁻³ radians when the input ray is angled by 1/30 radians with respect to the axis. This angle of 1/30 radians corresponds to output ray angle of 0.1 radians and it provides a practically sufficient view angle. The non-uniformity of less than 10⁻³ radians in the entire light beam is small enough to create a sharp image of the object.

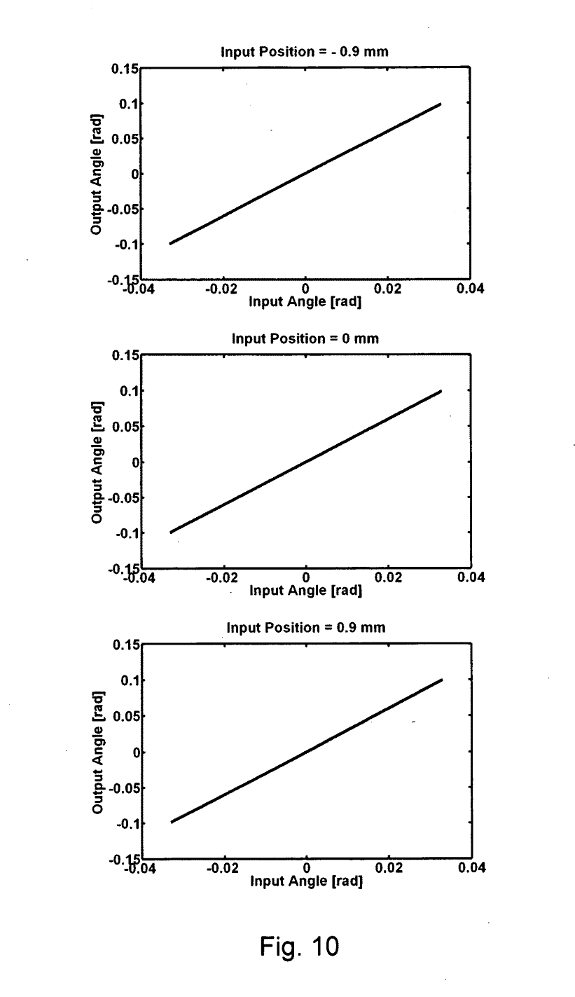

The linearity between the input ray angle and the output ray angle is shown in FIG. 10. The curves are calculated at three ray input positions, −0.9 mm, 0 mm, and 0.9 mm, which are one edge, the center, and the other edge of the MMM. In this calculation, too, it was assumed that the rays were not blocked by the concave mirror. The results indicate good linearity with a magnification of 3.

In the analysis above, it is assumed that the distance to the object is virtually infinite and the rays coming from a point on the object are parallel. It is also assumed that the eye is focusing at an object at infinity. In the practical field, these assumptions are not always true. The object may be at a finite distance and/or the eye may be short or long sight, which means that the eye may be focusing at a finite distance. In such cases, the optical designs can be optimized for the conditions. With the optimization, the concave mirror and the convex mirror may no longer share the focal point. To focus an object at a finite distance, the focal point of the concave mirror should be moved in the direction opposite to the object. To focus for short sight eye, the focal point of the convex mirror should be moved in the direction toward the eye. To move the position of the focal point, either physical position or geometrical curve of the mirror may be changed.

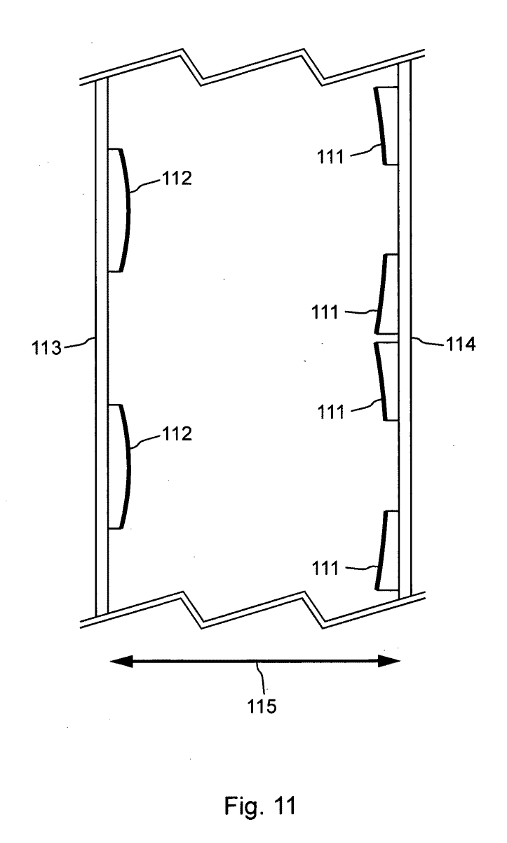

An embodiment of a magnifier plate that is easily adjustable to achieve the objective just described is shown in FIG. 11. Here the magnifier plate comprises, instead of a single plate, two thin plates 113 and 114 spaced apart as shown. The concave mirrors 111 are affixed to the plate 114, or molded as part of the plates. The convex mirrors 112 are affixed to the plate 113, or molded as part of the plates. Two MMMs are shown as part of a larger plate as indicated by the cutaway lines. The spacing between the plates 115, and thus the spacing between the mirrors, is adjustable as indicated. This allows the focal points of the mirrors to be coincident or off-coincidence as required. The adjustment may be made by a suitable mechanical screw assembly or the like. Alternatively, since the adjustment is very small, it may be made electrically, using piezoelectric plates or functionally similar elements. This embodiment may have advantages, in addition to adjustability, in ease of fabrication. On the other hand, it adds additional refractive interfaces. Suitable anti-reflection measures are recommended.

The analysis above was carried out in one dimension. Similar parallelism of the output light rays is expected in a two dimensional analysis. In addition, both concave mirror and convex mirror were assumed to be parabolic mirrors. Modifications of the mirror shapes into non-parabolic mirrors may help further improve the parallelism of the output light rays.

The simplest form of magnifier plate is a two dimensional array of round MMMs built along a plane in the manner described above. The mirrors in the simple MMM are also round. However, it will be evident to those skilled in the art that an array of circular elements leaves significant void space between them. In an imaging device this void space is especially undesirable. Thus the simple geometrical array may be modified to produce improved results.

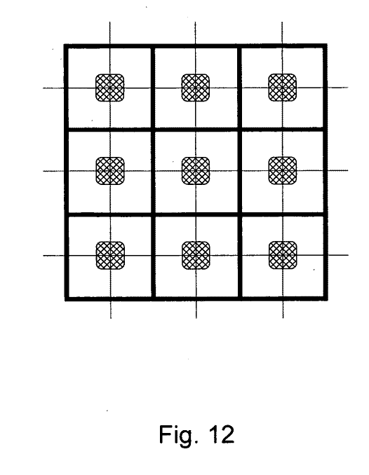

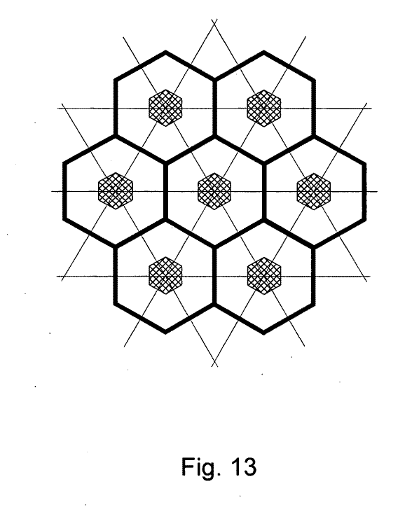

Two popular geometrical patterns of two dimensional arrays in a plane are with unit shapes of a square and a hexagon as shown by bold lines in FIGS. 12 and 13, respectively. Therefore, the edge of a light entrance window of each MMM, which forms the unit area, is a square or a hexagon. A collimated light beam entering each unit area is converted into a collimated light beam with a smaller beam width and is emitted from approximately the center of the unit area. The output light beam from each MMM has a cross section shape which reflects the shape of the light entrance window or the unit shape. That is, the shape of the cross section of the output beam is the same as the unit area but compressed by the factor which is inverse of the magnification. The cross sections of the output beams are indicated with hatched areas in FIGS. 12 and 13. With the given design parameters, the output beam width is ⅓ of the size of the unit area. If the unit shape is a square, the emitted beam positions, that are the centers of unit areas, create a square pattern (FIG. 12). If the unit shape is a hexagon, the emitted beam positions create an equilateral triangle pattern (FIG. 13).

The MMM has a hole at the center of the concave mirror. Since the area around the hole is a mirror, no light travels to the eye from the area other than the hole. The concave mirror works as an aperture and undesired light is blocked to help maintain a good image quality. As mentioned earlier, if the eye side of the concave mirror is black in color, the undesired reflections on the mirror can be avoided.

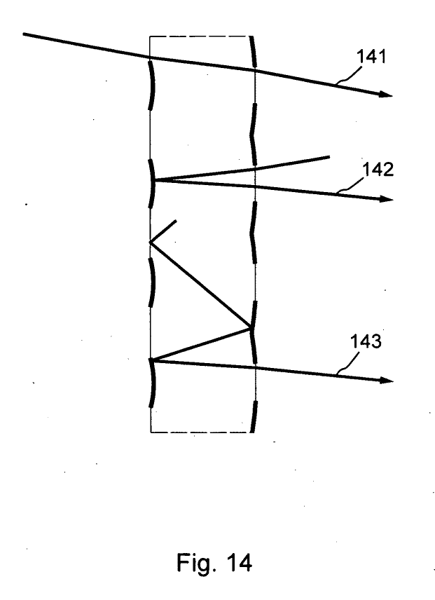

Three light paths which could cause degradation of image quality are shown in FIG. 14. The light of direct pass-through, 141, is the light traveling through the entrance window and the exit window without reflections by the mirrors. Since the size of the convex mirror is reasonably larger than the size of the light exit window, this light has a certain angle from the axis. Therefore, this light is out of the view angle. The light of direct reflection, 142, is the light entering the hole from the eye side and being reflected back by the convex mirror. The amount of this light can be estimated using FIG. 8. This light comes from the area that is an image of the hole viewed in the convex mirror. With the given design parameters, the diameter of the hole is about ⅓ of the size of the unit area and convex mirror compresses the image into a ⅓ size. Therefore, the image of the hole is about 1/9 in diameter and the estimated light power is about 1/81 or equivalent to 1.2% reflection. The light of multiple reflections, 143, is mainly the light traveling to the convex mirror from a neighboring concave mirror. With the given design parameters, the angle of this light at the entrance window is greater than the critical angle and the light cannot enter directly through the window.

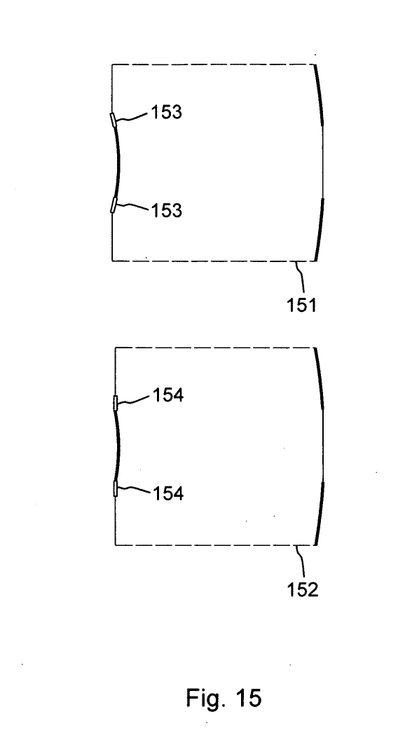

As indicated in FIG. 6, the diameter “b” of the convex mirror is designed to be greater than the diameter “c” of the light exit window. This condition of design is desirable to prevent the light of direct pass-through, illustrated at 141 in FIG. 14, from traveling within the view angle. However, as can be seen in FIG. 8, the light beam at position B does not hit the area near the edge of the convex mirror, even with off axis beams. Therefore, the area near the edge of the convex mirror does not necessarily need to be reflective. Actually, it may be better that the area near the edge of the convex mirror is light absorptive, such as black in color. This is because the light of multiple reflections, illustrated at 143 in FIG. 14, is reflected by the area near the edge of the convex mirror, and that light will be suppressed if the edge area is made absorptive as shown at 153 on an MMM (top), 151, in FIG. 15. This concept can be extended to a modified design where the area near the edge of the convex mirror can be in any shape, not limited to the convex shape. For example, the area may be flat and in the same plane as the light entrance window as shown at 154 on an MMM (bottom), 152, in FIG. 15.

Also, as can be seen in FIG. 8, the light beam at position B does not hit the area near the center of the convex mirror. Therefore, if the area near the center of the convex mirror is light absorptive, such as black in color, the light of direct reflection illustrated at 142 in FIG. 14 can be reduced. In this case, too, the area near the center of the convex mirror can be in any shape, including flat.

As was explained earlier in FIG. 4, the gaps between the light beams do not affect, in principle, the image of the object created on the retina in the eye, as long as the gap is smaller than the diameter of the eye pupil. This is true, as long as the crystalline lens of the eye has no geometrical aberrations and does not respond to the entering beam position, which may or may not occur. If the crystalline lens has aberrations, the quality of the image may be affected. In this case, smaller gaps between the light beams will create an image of better quality in the eye. In other words, making the gap smaller than the eye pupil is only a minimum requirement. It is useful for creating an image of good quality that the gap is made even smaller. As shown in the one dimensional model of FIG. 4, the gap is determined by the transversal dimension of the MMMs and the width of light beams emitted from the MMMs. In the practical case using a two dimensional model, the gap is the spacing between the hatched areas in FIGS. 12 and 13. In the embodiments discussed so far, the MMMs in a given magnifier plate are the same. However, they may be different one from another in structure and/or placement.

To realize small gaps using a reasonable size of the MMMs, the gap between the adjacent beams at the output of the magnifier plate may be reduced using another embodiment of the invention. This additional function is provided by a two dimensional array of MBMs, defined as a beam multiplier plate. The function and structure of the beam multiplier plate will be described below.

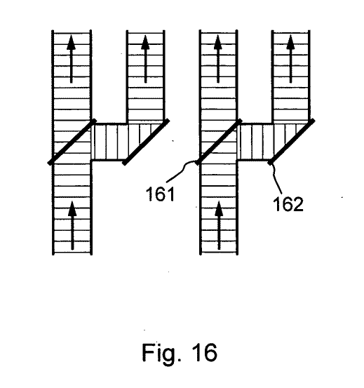

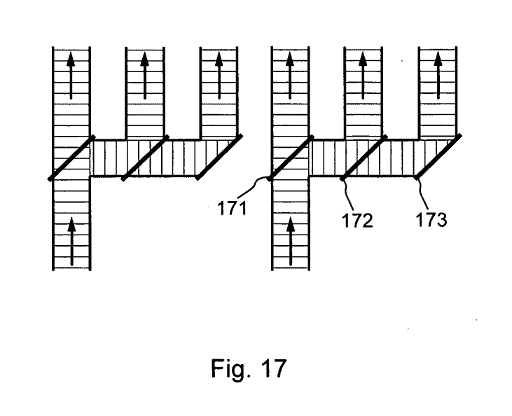

A MBM consists of a plurality of reflective surfaces, which are partial or total reflection mirrors shown schematically in FIGS. 16 and 17. Individual MBMs are positioned to receive the light beam emitted from each MMM and collectively produce multiple light beams having the identical beam profile and the same traveling angle. The total optical power is also unchanged by the MBMs. Therefore, new light beams are produced in the gaps between adjacent light beams from the MMMs. This effectively reduces the size of gaps, and in some cases, almost eliminates the gaps.

The function of two of many MBMs in one dimension in the array splitting the primary beam into two beams are illustrated in FIG. 16. The function of two of many MBMs in one dimension in the array splitting the primary beam into three beams are illustrated in FIG. 17. They employ partial and total reflection mirrors, 161, 162, 171, 172, and 173. The optical powers among the output beams do not necessarily need to be equal. They can be made equal if, in the case of FIG. 16, the reflectivities are 161=50% and 162=100%, and in the case of FIG. 17, the reflectivities are 171=67%, 172=50%, and 173=100%.

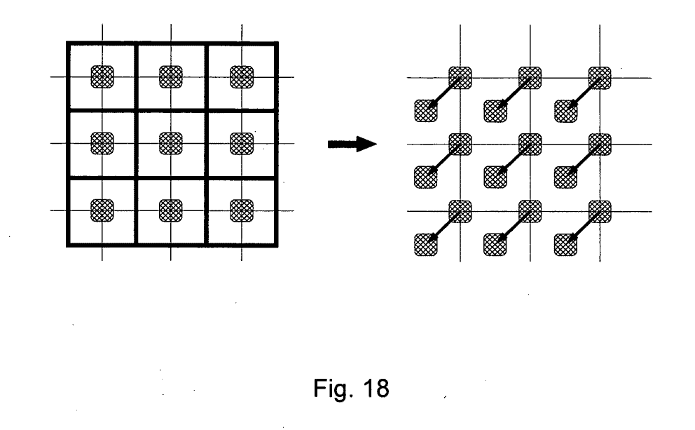

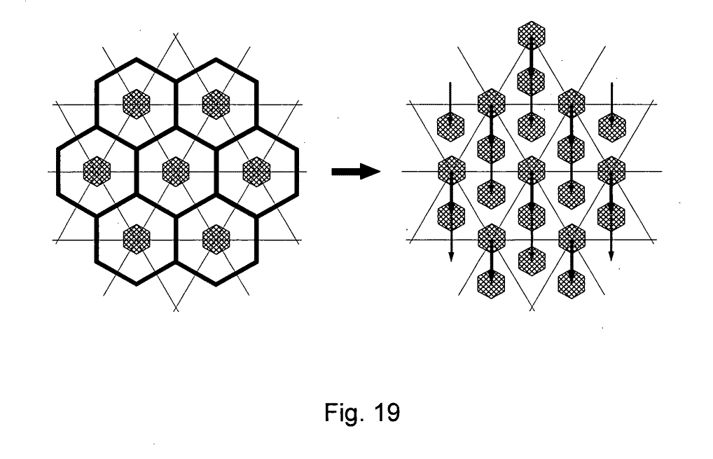

For illustration, MBMs for two beam output as shown in FIG. 16 may be used for the magnifier plate with a square unit shape and MBMs for three beam output as shown in FIG. 17 may be used for the magnifier plate with a hexagon unit shape. In the case of the square unit shape as shown in FIG. 12, each light beam emitted from a unit area is converted into two light beams, one at the original position and the other moved by 1/\sqrt{2} of the length of side of the square as shown in FIG. 18. In the case of the hexagon unit shape as shown in FIG. 13, each light beam emitted from a unit area is converted into three light beams, first at the original position, second moved by 1/\sqrt{3} of the length of side of the equilateral triangle, and the last moved by 2/\sqrt{3} of the length of side of the equilateral triangle, as shown in FIG. 19.

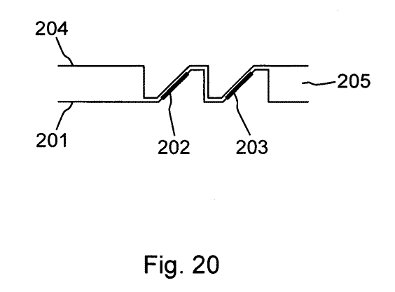

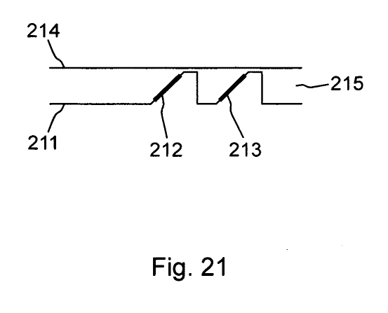

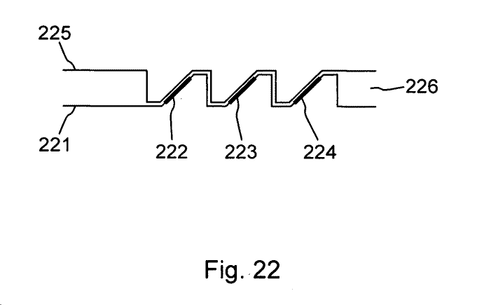

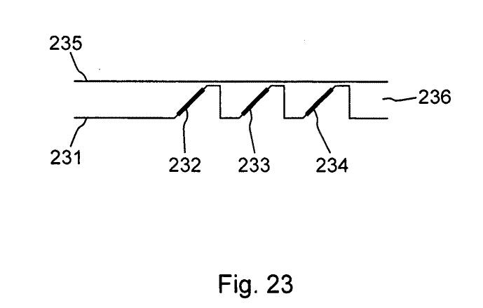

A practical beam multiplier plate may be fabricated using two plates, a base plate and a top plate, assembled together. An actual base plate may have an array of micro prisms on its surface. More precisely, the surface shape is with processes of trapezoid or triangle prisms. To implement the beam multiplier plate of FIG. 16, i.e., one beam to two beams, the base/top plates of FIG. 20 or 21 may be used. In FIGS. 20 and 21, the upper surfaces of the base plates 201 and 211 support an array of trapezoid prisms. The hypotenuses of the prisms 202 and 212 on the base plate have coatings corresponding to 161 in FIG. 16 and the hypotenuses of the prisms 203 and 213 on the base plate have coatings corresponding to 162 in FIG. 16. The lower surface of the top plate 204 in FIG. 20 has a mating surface with similar processes of trapezoid prisms and the lower surface of the top plate 214 in FIG. 21 is planar. To implement the beam multiplier plate of FIG. 17, i.e., one beam to three beams, the base/top plates of FIG. 22 or 23 may be used. In FIGS. 22 and 23, the upper surfaces of the base plates 221 and 231 support an array of trapezoid prisms. The hypotenuses of the prisms 222 and 232 on the base plate have coatings corresponding to 171 in FIG. 17, the hypotenuses of the prisms 223 and 233 on the base plate have coatings corresponding to 172 in FIG. 17, and the hypotenuses of the prisms 224 and 234 on the base plate have coatings corresponding to 173 in FIG. 17. The lower surface of the top plate 225 in FIG. 22 has a mating surface with similar processes of trapezoid prisms and the lower surface of the top plate 235 in FIG. 23 is planar. In each of FIGS. 20-23, the space between the base plate and the top plate is preferably filled with an index matching medium 205, 215, 226, and 236.

FIGS. 20-23 illustrate the case of trapezoid prisms and the shape of the surface in one dimension is shown as a side view in the figures. In the case of triangle prisms, the flat portion of the trapezoid prism at the top simply does not exist.

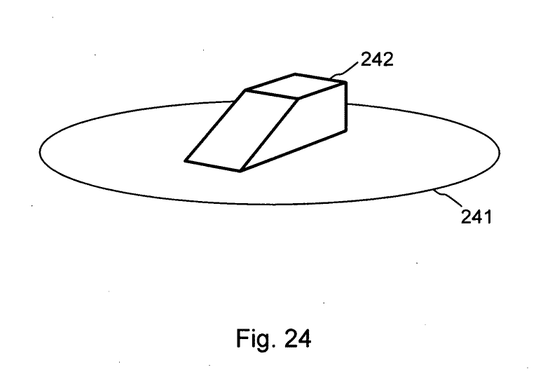

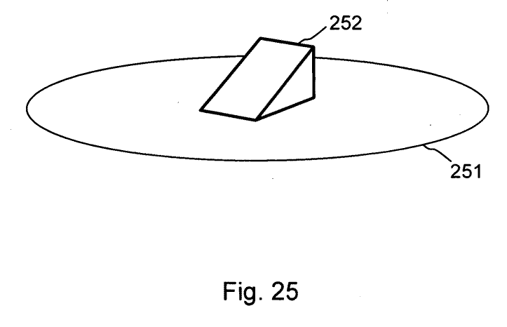

In some cases, each MBM in the beam multiplier plate receives only the light beam emitted from a particular MMM. To receive a light beam emitted from a particular MMM only, the dimension of the trapezoid or triangle prism perpendicular to the plane of FIGS. 20-23 may need to be close to the size of the light beam diameter, or the size of the MMM. In such a case, to satisfy this requirement, the trapezoid or triangle prisms need to be three dimensional prisms. As an example, a base plate is shown in FIG. 24 with a single trapezoid prism 242 on the upper surface 241 of the base plate. As an example of a triangle prism, the prism 252 on the upper surface 251 of the base plate is illustrated in FIG. 25. As mentioned earlier, the hypotenuses of the prisms on the base plate have coatings with a reflectivity 50%, 67%, 100%, or other. Therefore, the trapezoid prism shown in FIG. 24 forms any one of processes of the trapezoid prisms in FIGS. 20-23, with the reflectivity on the hypotenuse surface 50%, 67%, 100%, or other. When the base plate and the top plate are assembled together, the beam multiplier plate with the function of FIG. 16 and/or FIG. 17 is formed.

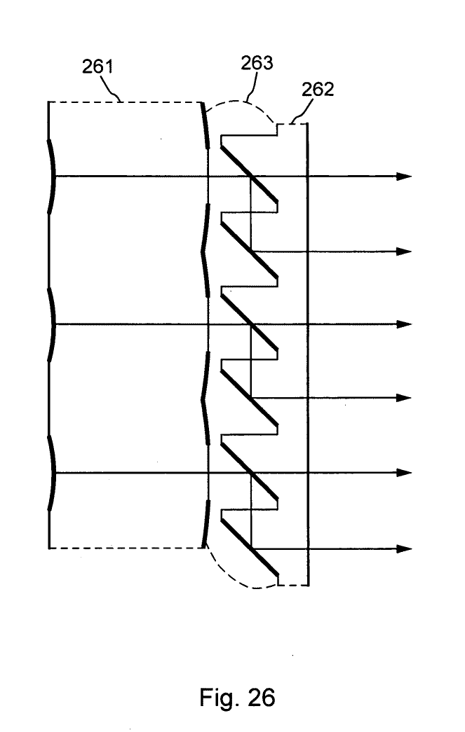

It is noted that the top plate with a flat surface may be omitted if the prism side of the base plate is directly faced with the MMMs and the space between the base plate and the MMMs is filled with an index matching medium. As an example, the structure of the magnifying apparatus using MBMs that convert one beam into two beams is illustrated in FIG. 26, where the magnifier plate is shown at 261, the beam multiplier plate is shown at 262, and an index matching material is shown at 263.

To reduce optical losses, it is desirable to apply anti-reflection coatings to surfaces of the components, or to use reduced reflection surfaces for the components, or to match the index with the external medium.

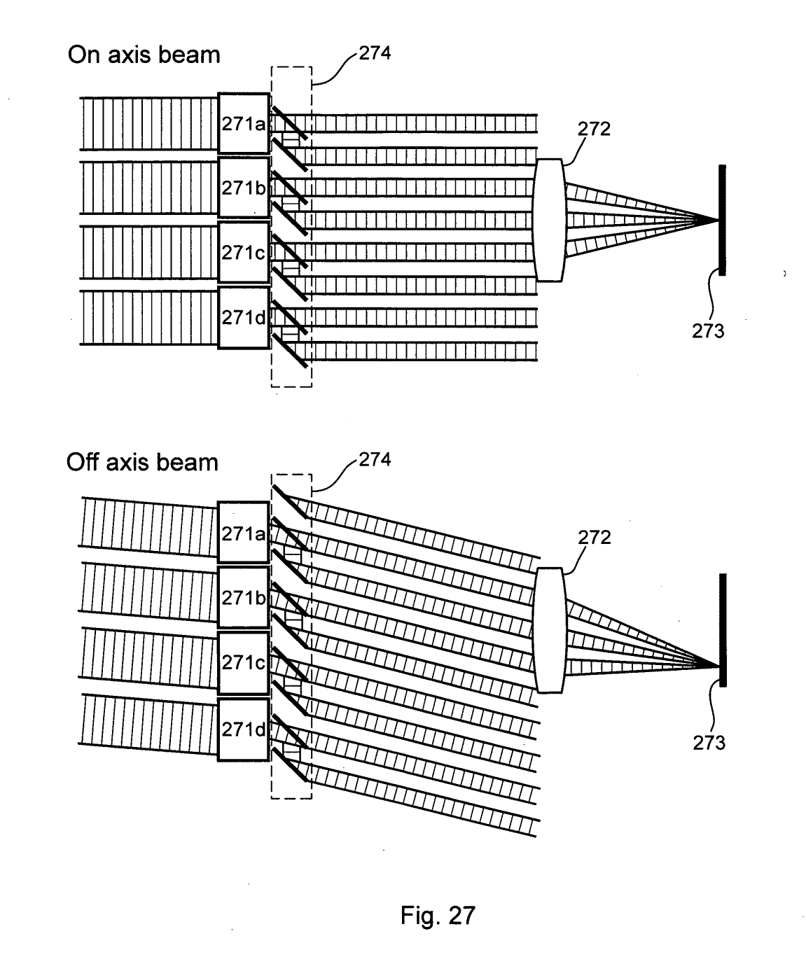

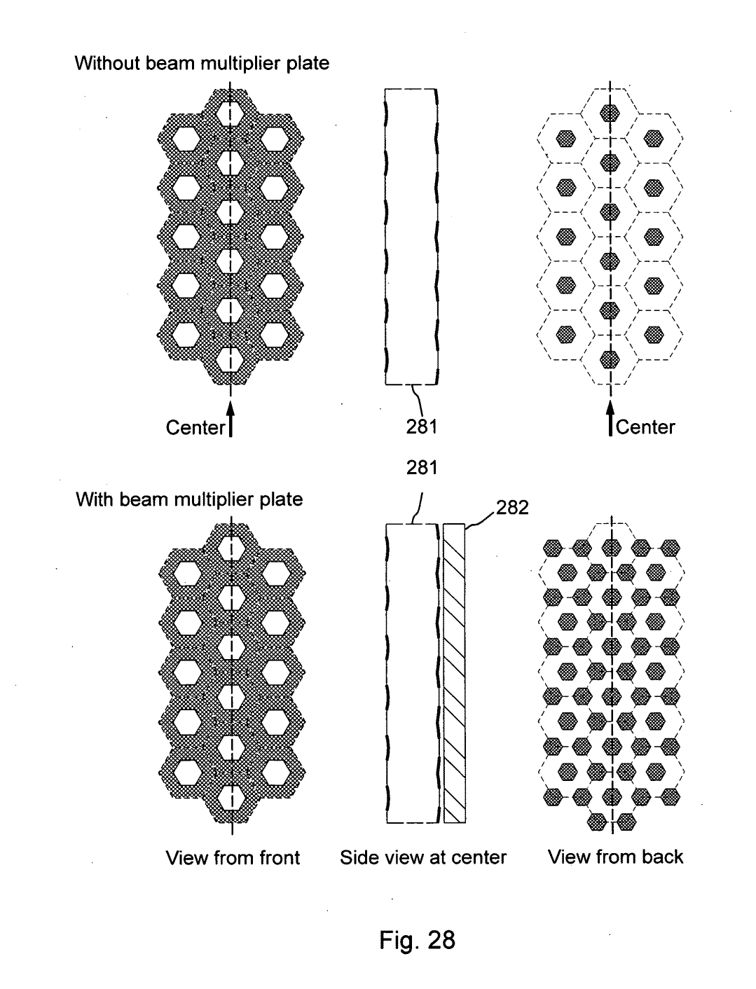

The side view of the light beams is shown in FIG. 4 when the beam multiplier plate is not used. When the beam multiplier plate is used, the side view of the light beams is illustrated in FIG. 27, where the reduced gaps between the light beams traveling toward the eye are evident. In FIG. 27, the magnifier plate comprises MMMs 271a-271d, the beam multiplier plate is shown at 274, and the crystalline lens and retina of the eye are shown at 272 and 273, respectively. The effect of using the beam multiplier plate is better illustrated in two dimensions in FIG. 28. This figure assumes that the unit shape of the MMM is hexagonal, the MBM produces three light beams from one beam, and the beam multiplication is performed in the way of FIG. 19. In FIG. 28, the view from the front shows the light entrance windows of the magnifier plate 281 with hatched areas. The white areas are areas where the light is blocked by the convex mirrors. In the view from the back, hatched areas show the areas from which the light is emitted. The effective gaps between the output light beams are the spacing between the hatched areas. Comparing the views from the back in FIG. 28 (top), the magnifying apparatus with a magnifier plate 281 but no beam multiplier plate, and FIG. 28 (bottom), the magnifying apparatus with a magnifier plate 281 and an added beam multiplier plate 282, it is obvious that the gaps are significantly reduced by using the beam multiplier plate.

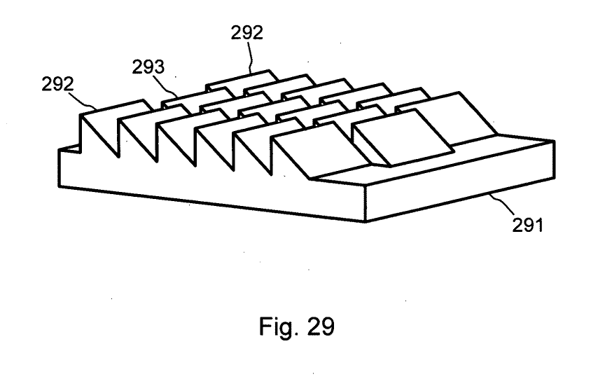

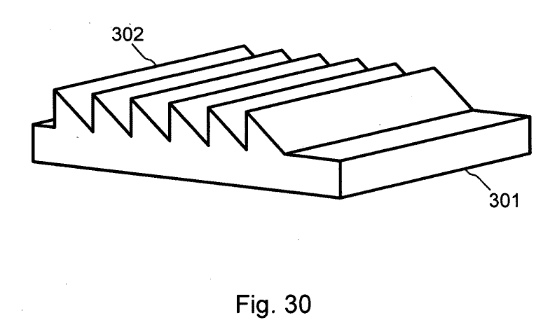

The gaps between the light beams can be further reduced by cascading the beam multiplier plates. Two examples of surface shapes for base plates of beam multiplier plates with triangle prisms are shown in FIGS. 29 and 30. In FIG. 29, each of prisms 292 and 293 built on the base plate 291 receives only one of light beams emitted from MMMs. In this case, prisms 292 are in every other columns, prisms 293 are in columns between the columns of 292, and rows with prisms 292 and rows with prisms 293 are out of phase by half the period. In FIG. 30, each of prisms 302 built on the base plate 301 receives multiple light beams emitted from MMMs. In this case, rows in all columns are in phase.

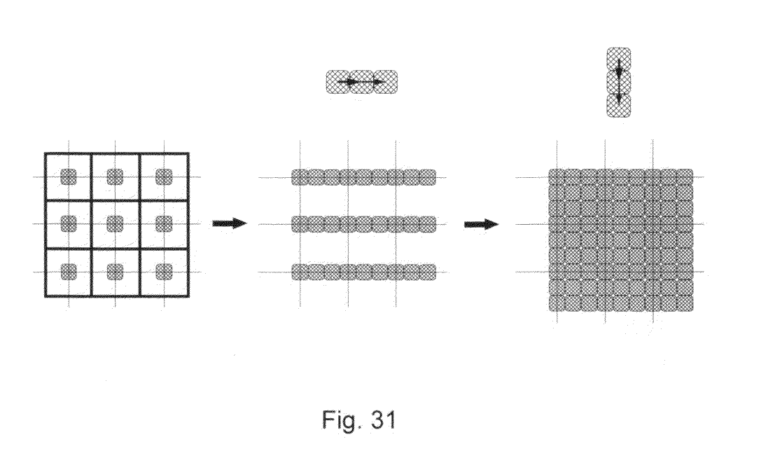

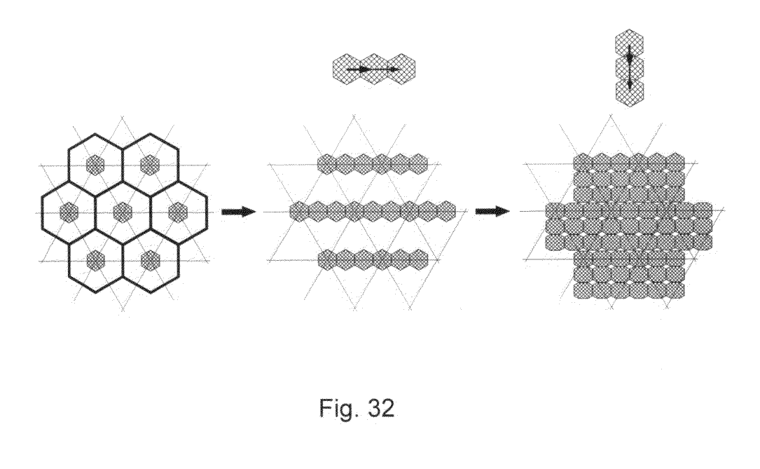

If two of the plates illustrated in FIG. 30 are cascaded, where one produces light beams in the horizontal direction and the other produces light beams in the vertical direction, the gaps with the unit area of a square can be almost eliminated. This is illustrated in FIG. 31. Similarly, if the plates illustrated in FIGS. 29 and 30 are cascaded, where one produces light beams in the horizontal direction and the other produces light beams in the vertical direction, the gaps with the unit area of a hexagon can be significantly reduced. This is illustrated in FIG. 32. There are several designs to cascade the beam multiplier plates whether the top plates are used or not. One design is to build the first prism array on one side of the base plate and the second prism array on the other side of the base plate. Another design is to combine two separate base plates with a prism array on one side of each base plate.

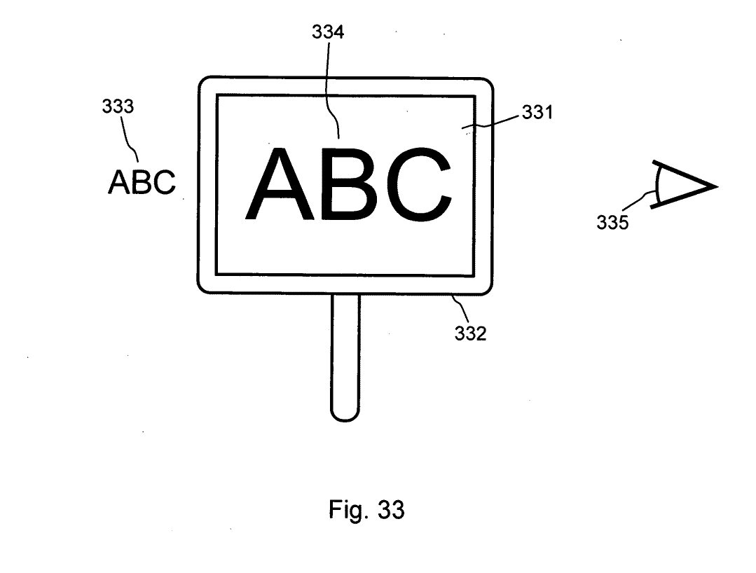

The combination of the magnifier plate and the beam multiplier plate can be built within a thin plate. With the design parameters used for the analysis described earlier, the total thickness of the plate combination is about 3 mm. This plate combination itself can be used to view the image of an object at a distance by simply looking through the thin plate. As shown in FIG. 33, a thin plate of the magnifying apparatus 331 can be held by a frame 332 with a handle. This handling is similar to a conventional magnifier to view an object at a short distance. Unlike conventional magnifiers, the object “ABC” 333 is far away or at infinity. By looking at the object through the magnifying apparatus, the eye 335 sees the magnified image 334 of the object.

One potential application of the invention is for eyeglasses. If eyesight is poor, it is usually corrected by using eyeglasses. However, if the poor eyesight is caused by complicated distortions of the crystalline lens or defects of the retina, eyeglasses may not be able to recover eyesight. In such cases, magnifying the image is a practical solution to view the object. The magnifying apparatus of the present invention can be embedded in at least a portion of the eyeglass lenses, so the image can be magnified through that portion, when necessary. An alternative way to use the magnifying apparatus with eyeglasses is for the magnifying apparatus to be assembled in a frame held by a hinged temple, and attached to the eyeglasses. The magnifying apparatus may be turned down into the line of sight when necessary.

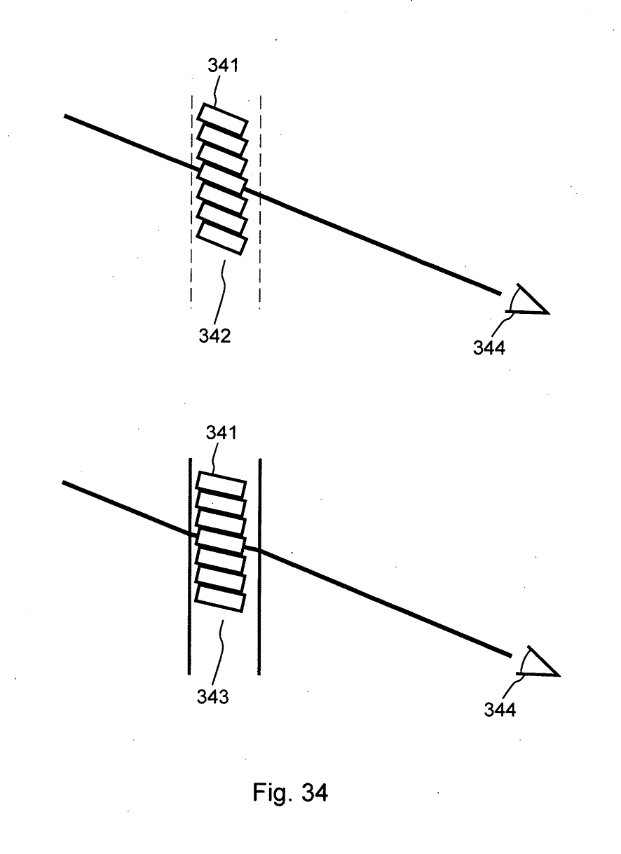

In applications of the magnifying apparatus of the present invention, the axis of the MMMs does not necessarily need to be exactly normal to the plane of the array. As shown in FIG. 34, if the direction of the eye 344 has an angle from the normal direction to the plane, individual MMMs 341 may be angled so that their axes are parallel to the direction toward the eye, but are not normal to the magnifier plate. This design of tilted MMMs helps reduce aberration of the MMMs. If the MMMs with or without the MBMs are placed in the air 342, the actual axes of the MMMs are toward the eye. If they are placed in a transparent magnifier plate 343 such as glass and plastic, the axes after the refraction at the surface of the magnifier plate are toward the eye.

This modification of tilted MMMs is especially useful when the magnifier plate is placed on an angled plane, such as for an automobile windshield.

It is noted that brightness of an image through the magnifying apparatus of the present invention is lower than that of the original image. This is because the spatial average of light energy remains the same through the apparatus and the light energy entering the eye pupil is unchanged by the apparatus (if no loss is assumed), while the image is magnified. Thus, the same amount of optical energy is distributed into the magnified image in the eye.

While the magnifying apparatus of the invention is intended primarily for viewing distant objects with the unaided eye, a variety of image enhancing devices, image display devices, and image detectors may be advantageously combined with the magnifying apparatus of the invention.

The MMM of the invention may be defined as a general prism. As shown in FIGS. 5 and 11, the prism may be solid or hollow. For the purpose of this description, a general prism is a polyhedron possessing two congruent polygonal faces, and with all remaining faces parallelograms. In one preferred embodiment, the congruent polygonal faces of the prism are rectangular, making the prism a cuboid. In another preferred embodiment, the congruent polygonal faces of the prism are hexagonal. The two congruent polygonal faces of the prism are referred to here for convenience as major faces. The major faces are two opposing faces that are parallel. One of the major faces, the input major face, is the input side of the MMM and the other major face, the output major face, is the output side of the MMM. In the preferred case, the light being processed is incident on the input major face at an approximately 90 degree angle (normal incidence). Likewise in the preferred case, the light exiting from the MMM exits at an approximately 90 degree angle with respect to the exit major face.

The input major face comprises a convex mirror located in the approximate center of the input major face. A reflective face of the convex mirror faces the interior of the MMM with the focal length of the convex lens extending from the convex mirror away from the MMM. The convex mirror covers a portion of the input major face (referred to as the covered portion), leaving exposed another portion of the major face surrounding the convex lens (referred to as the uncovered portion). The output major face comprises a concave mirror approximately centered on the output major face. The concave mirror has an opening in the center of the concave mirror, where the center portion of the output major face is exposed. The focal length of the concave mirror extends through the MMM to a point outside the input major face.

The array of MMMs may comprise an array of prisms just described, but is preferably integrated into a plate. For the purpose of defining the invention, an array of MMMs, as defined above, should be construed as including either an array of discrete MMMs suitably mounted on a two dimensional plate, or a single plate having multiple MMMs formed in or on the plate. The MMMs may be described as having the form of general prisms, cuboids or cubes, which shapes will be evident in a form of the array wherein the MMMs are discrete, but the side boundaries of the geometric solids vanish in the integrated form.

In concluding the detailed description, it should be noted that it will be obvious to those skilled in the art that many variations and modifications may be made to the preferred embodiment without substantial departure from the principles of the present invention. All such variations, modifications and equivalents are intended to be included herein as being within the scope of the present invention, as set forth in the following claims.

1. An optical apparatus comprising a two dimensional array of micro magnifying modules (MMMs), each MMM comprising a transparent body, the transparent body comprising a light convergent element followed by a light divergent element along the axis of light travel, wherein the input light beam of the optical apparatus is nearly collimated, and is converted into an output light beam of the optical apparatus consisting of a plurality of nearly collimated light beams with gaps between the beams, wherein the size of the gap is smaller than 2 mm.

2. An optical apparatus comprising a two dimensional array of micro magnifying modules (MMMs), each MMM comprising a transparent body, the transparent body comprising:
a. a light input side of the transparent body comprising a convex mirror, with the focal length of the convex mirror extending away from the transparent body; the convex mirror covering a covered portion of the light input side of the transparent body leaving exposed an exposed portion of the transparent body,
b. a light output side of the transparent body on an opposing parallel side of the transparent body; the light output side comprising a concave mirror with the focal length extending through the transparent body, the concave mirror having an opening in the center of the concave mirror.

3. The optical apparatus of claim 1 further including a two dimensional array of micro beam multipliers (MBMs), wherein each MBM comprises at least one beam splitter for converting an input light beam into two or more output light beams with the same traveling angle located at positions moved in transversal directions with each other, with each MBM located adjacent to an MMM.

4. The optical apparatus of claim 2 wherein the convex mirror has a smaller radius and a shorter focal length than the concave mirror.

5. The optical apparatus of claim 2 wherein the concave mirror and the convex mirror have approximately a common focal point.

6. The optical apparatus of claim 2 wherein the shapes of the concave mirror and the convex mirror are parabolas or near parabolas.

7. The optical apparatus of claim 2 wherein the concave mirror and the convex mirror share a common center axis.

8. The optical apparatus of claim 2 wherein the exposed portion of the light input side of the MMM comprises the light entrance window and is a flat surface.

9. The optical apparatus of claim 2 wherein the exposed portion of the light input side of the MMM comprises the light entrance window and is an optical lens surface.

10. The optical apparatus of claim 2 wherein the opening in the concave mirror comprises the light exit window and is a flat surface.

11. The optical apparatus of claim 2 wherein the opening in the concave mirror comprises the light exit window and is an optical lens surface.

12. The optical apparatus of claim 2 wherein the transparent body is glass or plastic.

13. The optical apparatus of claim 2 wherein each concave mirror has a shape selected from the group consisting of a hexagon and a square.

14. The optical apparatus of claim 3 wherein the array of MBMs contains a plurality of partial or total reflection mirrors.

15. The optical apparatus of claim 3 wherein the output light beams of the MBM have the same traveling angle and beam profile and/or equal optical power.

16. The optical apparatus of claim 2 wherein each MMM in the two dimensional array is angled from the direction of the plane of the array.

17. The optical apparatus of claim 2 wherein the thickness of the two dimensional array is in the range 1-8 mm.

18. An optical apparatus comprising:
a. a two dimensional array of micro magnifying modules (MMMs), each MMM comprising a transparent body, the transparent body comprising:
i. a light input side of the transparent body comprising a convex mirror, with the focal length of the convex mirror extending away from the transparent body; the convex mirror covering a covered portion of the light input side of the transparent body leaving exposed an exposed portion of the transparent body,
ii. a light output side of the transparent body on an opposing parallel side of the transparent body; the light output side comprising a concave mirror with the focal length extending through the transparent body, the concave mirror having an opening in the center of the concave mirror,
b. a two dimensional array of micro beam multipliers (MBMs), wherein each MBM comprises at least one beam splitter for converting an input light beam into two or more output light beams with the same traveling angle located at positions moved in transversal directions with each other, with each MBM located adjacent to an MMM.

19. The optical apparatus of claim 18 wherein the input light beam of the optical apparatus is nearly collimated, and is converted into an output light beam of the optical apparatus consisting of a plurality of nearly collimated light beams with gaps between the beams, wherein the size of the gap is smaller than 2 mm.

20. An optical apparatus comprising:
a. a two dimensional array of micro magnifying modules (MMMs), and
b. a two dimensional array of micro beam multipliers (MBMs), wherein each MBM comprises at least one beam splitter for converting an input light beam into two or more output light beams with the same traveling angle located at positions moved in transversal directions with each other, with each MBM located adjacent to an MMM.
